(19) United States
(12) Patent Application Publication
(10) Pub. No.: US 2012/0284040 A1
(43) Pub. Date: Nov. 8, 2012

(54) Medical Modules and Monitoring Systems

(76) Inventor: Kenneth Joe Dupin, Salem, VA (US)

(21) Appl. No.: 13/457,204

(22) Filed: Apr. 26, 2012

Related U.S. Application Data
(60) Provisional application No. 61/479,027, filed on Apr. 26, 2011.

(51) Int. Cl. G06Q 50/22; E04B 1/00; E04H 14/00; H04N 7/18

(52) U.S. Cl. 705/2; 348/77; 52/1; 52/173.1; 348/E07.085

(57) ABSTRACT

The present invention relates to portable dwellings, rooms, and patient monitoring systems for promoting an independent living or assisted living environment. More particularly, the present invention relates to strong, portable housing equipped with monitoring and air pressurization systems, which can be installed next to a caregiver's home or within a room in the caregiver's home. In preferred embodiments, provided is a portable dwelling comprising: walls and a roof in a fixed exterior configuration, wherein the walls will not fail under wind resistance of up to 200 mph; a positive or negative pressure system for keeping contaminants out of or in the interior; and a patient monitoring system comprising means for capturing an image of a patient in a room, a means for remotely transmitting the image to a caregiver and having the ability to communicate only a restricted or selective view of the image to the caregiver.

### CROSS-REFERENCE TO RELATED APPLICATIONS

The present application claims priority to and the benefit of the filing date of U.S. Provisional Application No. 61/479,027, filed Apr. 26, 2011, the disclosure of which is hereby incorporated by reference herein in its entirety.

### BACKGROUND OF THE INVENTION

1. Field of the Invention

The present invention relates to portable dwellings, rooms, and patient monitoring systems for promoting independent living or providing for an assisted living environment away from a hospital or nursing home and close to the primary caregiver's home. More particularly, the present invention relates to strong, portable housing equipped with monitoring and air pressurization systems, which can be installed as stand-alone structures next to a caregiver's home or installed as a room within a room in the caregiver's home.

2. Description of Related Art

Individuals in need of end-of-life care have limited options available concerning where that care is provided. Typically, the choices include hospice, a nursing home, a hospital, in home care, or in a caregiver's home. For those individuals requiring constant medical attention and/or monitoring, there is usually only one choice, a hospital. Hospitals have the needed medical equipment, including monitoring systems and isolation rooms, as well as around-the-clock medical personnel. Hospitals, however, are not always convenient for family members to visit due to location and/or restrictions on visiting hours. Patients and their loved ones who do not have frequent in-person contact with one another during this phase of life often live less fulfilling lives in these end stages. Further, those patients who have the potential to recover but do not have frequent in-person contact with family and friends often take longer periods of time to fully recover.

Hospitals are also notorious as potential breeding grounds for infectious disease. In the United States, for example, the Centers for Disease Control and Prevention estimate that roughly 1.7 million hospital-associated infections, from all types of microorganisms, including bacteria, combined, cause or contribute to 99,000 deaths each year. See Pollack, Andrew, “Rising Threat of Infections Unfazed by Antibiotics,” New York Times, Feb. 27, 2010. “Superbugs,” such as SARS (sudden acute respiratory syndrome) and MRSA (methicillin-resistant Staphylococcus aureus), once contracted are difficult to treat. As a result, it can be risky for patients to stay in the hospital, especially for patients with compromised immune systems. Even further, visitors of a patient in the hospital are also at risk of exposure to these sometimes deadly diseases, thus hospital visits from loved ones are usually further restricted to adult family members and friends not suffering from a compromised immune system.

Hospitals often house patients with infectious diseases in isolation rooms or wards, but these facilities are not always secure against contagions. Accordingly, the patient himself or other patients in the facility may be at risk of contracting disease while in the hospital due to breaches in contagion safety measures. Patients having compromised immune systems are treated in hospital rooms having a positive air pressurization system in place to constantly force air out of the room and keep any contagions present in other regions of the hospital out of that patient's room. Similarly, the typical manner for containing infectious agents in public facilities is to use isolation rooms with negative air pressurization systems to keep airflow flowing into the infected patient's room at all times instead of outward. In this manner, the contagions in a patient's room will remain in the room or be filtered out to avoid the risk of potential infection to other patients in other rooms of the hospital. In a study, however, from 1992-1998, the New York State Department of Health evaluated 140 designated isolation rooms in 38 facilities, 60% of which were hospitals and nursing homes, and found 38% having inappropriate outward airflow. See Pavelchak N. et al., “Identification of factors that disrupt negative air pressurization of respiratory isolation rooms,” Infect. Control Hosp. Epidemiol., 2000 Mar. 21(3): 191-5. Thus, there is a need for other medical facility options that offer less risky exposure to potential contagions and greater control and monitoring of the installed safety measures.

Family members who desire to provide end-stage care or near end-stage care for other family members, such as elderly parents, often cannot due to time constraints imposed primarily from assisting the parent in a location away from home, as much of the person's time is consumed traveling to and from the hospital. Taking care of a family member at one's home or even the family member's home usually requires expensive adjustments be made to the living quarters, such as installing stair lifts or building structural additions to better accommodate the medical needs of the parent patient. As these modifications are needed only for the short term, usually less than 1 yr, the caregiver may elect to get by without the improvements, making care giving even more physically taxing on the caregiver.

With respect to monitoring of patients, hospitals, nursing homes, and other patient care facilities typically include patient monitoring devices at one or more bedsides in the facility. Patient monitoring devices generally include sensors, processing equipment, and displays for obtaining and analyzing a medical patient's physiological parameters. Physiological parameters include, for example, respiratory rate, SpO₂ level, pulse, and blood pressure, among others. Clinicians, including doctors, nurses, and certain other medical personnel use the physiological parameters obtained from the medical patient to diagnose illnesses and to prescribe treatments. Clinicians also use the physiological parameters to monitor a patient during various clinical situations to determine whether to increase the level of medical care given to the patient. In addition, these medical monitoring devices employ systems and software to detect and identify specific human movements or postures, which are predictors of certain activities so that interested third parties may be notified of patients in bed who have been identified as a fall risk. The growth in the number of older adults and the continuing desire of the elderly to live independently has led to more aggressive efforts to promote independent living and expansion in monitoring the well being of elderly individuals for all possible living environments, including independent living environments.

Human falls are the leading cause of injury for persons over the age of 65 and can occur in any environment, including hospitals, long term care, retirement housing or single family dwellings. Falls are especially prevalent when the patients under care generally have reduced physical or mental capacity. The occurrence of falls in health care environment is so pronounced that the reduction of the number of injuries resulting from patient falls is one of the Joint Commission's patient safety goals. Given the occurrence of falls, the need to monitor and report has become a critical element of society. Falls can occur during any activity, however, the great percentage of incidences occur when an individual transitions from lying down or sitting.

Monitoring human activity is not limited to fall risk individuals. General monitoring of elderly who live alone is a prime activity monitoring application. Many other applications exist, for example, with independent living of a disabled relative. There are a number of different elderly patient monitoring systems and methods disclosed in the prior art. Most of the monitoring systems disclosed involve some contact with the patient and therefore the patient cannot live independently. Another considerable drawback of the monitoring systems and methods described in prior art is that they have a very large field of view and disregard the privacy of the person being monitored. All disclosed monitoring systems in the prior art incorporate the requirement to have someone close by that may respond to an alarm, therefore none of the systems promote independent living.

Accordingly, there is a need for living units that can be placed in close proximity to a caregiver's home to provide a better alternative to conventional healthcare facilities. Improved monitoring systems that provide caregivers with reliable notification without compromising the individual's privacy and ability to live independently are further needed to promote independent living of those in need of monitoring.

### SUMMARY OF THE INVENTION

The numerous limitations inherent in the independent living of elderly or disabled individuals described above provide great incentive for new, better living units and monitoring systems and methods capable of accounting for one or more of these issues.

To this end, embodiments of the present invention provide durable, pre-assembled housing units capable of being installed as stand-alone structures on the real estate property of a caregiver. Such housing units can be equipped with the medical equipment needed to satisfy a patient's particular needs, including monitoring systems that promote independent living yet provide for patient safety without compromising their privacy.

Preferred embodiments provide a portable dwelling comprising: walls and a roof in a fixed exterior configuration enclosing a housing interior, wherein, when installed for use, the walls will not fail under wind resistance of up to 200 mph; a positive or negative pressure system for pushing air out of or pulling air into the housing interior at a selected rate and for keeping contaminants out of or in the interior; and a monitoring system with means for monitoring environmental and patient conditions within the housing interior and means for alerting a caregiver to conditions that do not meet patient-specific criteria, wherein the monitoring system includes visual means for observing the patient at any time and at any position within the housing interior. These structures can be provided as stand-alone housing or be made to retro-fit a room in a caregiver's home, such as a garage.

Embodiments further include a portable room comprising: walls and a ceiling in a fixed exterior configuration enclosing a housing interior operably configured for installation in a garage in a modular manner or as a unitary structure; a positive or negative pressure system for pushing air out of or pulling air into the housing interior at a selected rate and for keeping contaminants out of or in the interior; and a monitoring system with means for measuring and monitoring environmental and patient conditions within the housing interior and means for communicating the conditions to a caregiver and means for alerting a caregiver to conditions that do not meet patient-specific criteria, wherein the monitoring system includes visual means for observing the patient at any time and at any position within the housing interior.

Embodiments of the invention include pre-assembled structures comprising: a kitchen, a bathroom, a living room and a plurality of monitoring systems; wherein said pre-assembled structure houses an individual in need of monitoring on or near the property of their caregiver.

Monitoring systems of the invention include a privacy-conscious patient monitoring system comprising: means for capturing an image of a patient in a room; means for transmitting the image in whole to a caregiver in a remote location; and means for communicating only a restricted view of the image to the caregiver by blacking out or distorting an undesired portion of the image. In such embodiments, a virtual object or other obstruction of part of the image may be used to protect the individual's privacy.

Embodiments of the invention provide virtual assistants to provide reminders and instructions to patients at specified times concerning medical or other issues.

Further embodiments provide patient record systems operably configured to store a patient's entire medical history and be accessible only by certain caregivers, under specified conditions, and at specific times, while the patient retains control of and access to the file and is capable of accessing the information at any time.

The features of novelty and various other advantages that characterize the invention are pointed out with particularity in the claims forming a part hereof. However, for a better understanding of the invention, its advantages, and the objects obtained by its use, reference should be made to the drawings that form a further part hereof, and to the accompanying descriptive matter, in that there is illustrated and described a preferred embodiment of the invention. The features and advantages of the present invention will be apparent to those skilled in the art. While numerous changes may be made by those skilled in the art, such changes are within the spirit of the invention.

### BRIEF DESCRIPTION OF THE DRAWINGS

The accompanying drawings illustrate certain aspects of some of the embodiments of the present invention, and should not be used to limit or define the invention. With the written description, the drawings serve to explain certain principles of the invention.

FIG. 1 is a schematic rendering illustrating an exemplary control panel for user interfaces of monitoring systems of the invention, which is used for monitoring a system that includes wellness, health, comfort, safety, and security monitoring systems.

FIG. 2 is a schematic rendering illustrating an exemplary control panel for user interfaces of monitoring systems of the invention, which is used for monitoring comfort of a patient, including one or more of lighting, inside temperature, outside temperature, ventilation, pressurization, and filtration.

FIG. 3 is a schematic rendering showing a system and exemplary user interface for monitoring one or more of systolic and diastolic blood pressure, oxygen levels, heart rate, body temperature, patient weight, and historical data.

FIG. 4 is a schematic rendering showing a system and exemplary user interface for monitoring patient safety, including recent patient activity in one or more rooms and real-time monitoring of the patient's location within the space being monitored.

FIG. 5 is a schematic rendering showing an exemplary system and user interface for monitoring patient location with capabilities for zooming in on a particular view of the patient or room and for implementing a patient virtual privacy curtain.

FIG. 6 is a schematic rendering showing a system and exemplary user interface for monitoring patient security, including monitoring one or more of smoke detection, leak detection, gas detection, door and window lock activation, door and window closed or open status, and outside video security.

FIG. 7 is a schematic rendering showing the system of FIG. 6, in which the user of the system can zoom in on the video surveillance image.

FIG. 8 is a schematic drawing showing a top perspective view of an embodiment of the portable dwelling unit of the invention.

FIG. 9 is a schematic drawing showing a front elevation view of an embodiment of the portable dwelling unit of the invention.

FIG. 10 is a schematic drawing showing a rear elevation view of an embodiment of the portable dwelling unit of the invention.

FIG. 11 is a schematic drawing showing a right end elevation view of an embodiment of the portable dwelling unit of the invention.

FIG. 12 is a schematic drawing showing a left end elevation view of an embodiment of the portable dwelling unit of the invention.

FIG. 13 is a schematic drawing showing a front elevation view of the skeletal structure of an embodiment of the portable dwelling unit of the invention.

FIGS. 14-26 are schematic drawings showing various systems and user interfaces for the monitoring systems of the invention.

### DETAILED DESCRIPTION OF PREFERRED EMBODIMENTS

One of the many potential advantages of the methods of the present invention, only some of which are discussed herein, is that the invention provides improved living units for individuals in need of monitoring that allow for increased privacy and independent living. The modular structures of the present invention may be placed in close proximity to the homes of relatives thereby allowing for independent living yet also remaining in close proximity to the caregivers. In addition, the modular structures of the present invention comprise monitoring systems that may allow for improved medical monitoring, safety monitoring, comfort monitoring, and security monitoring.

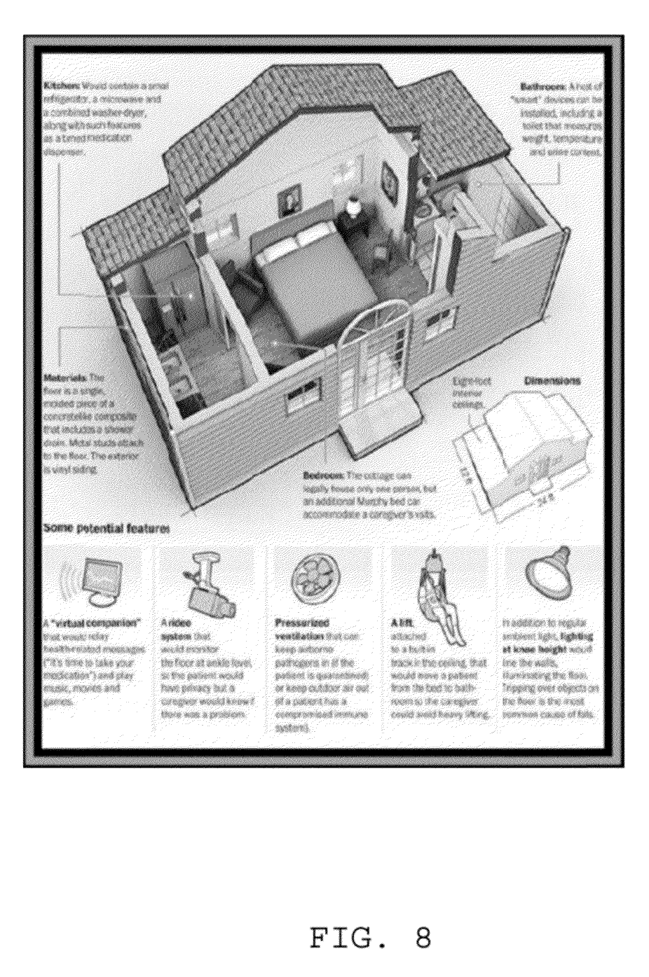

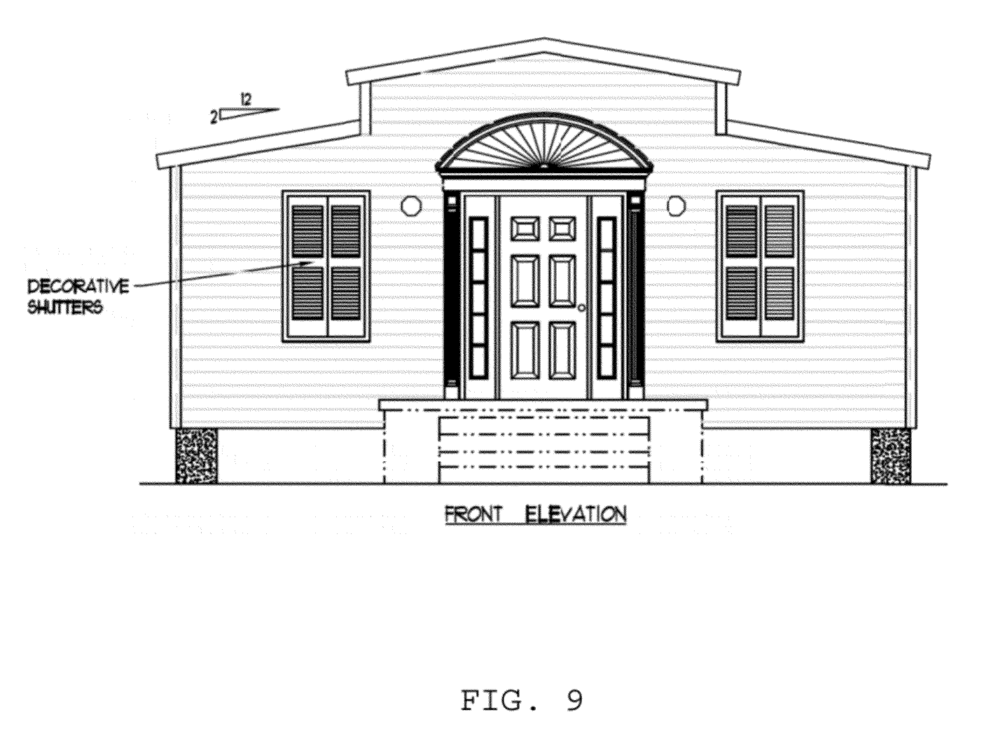

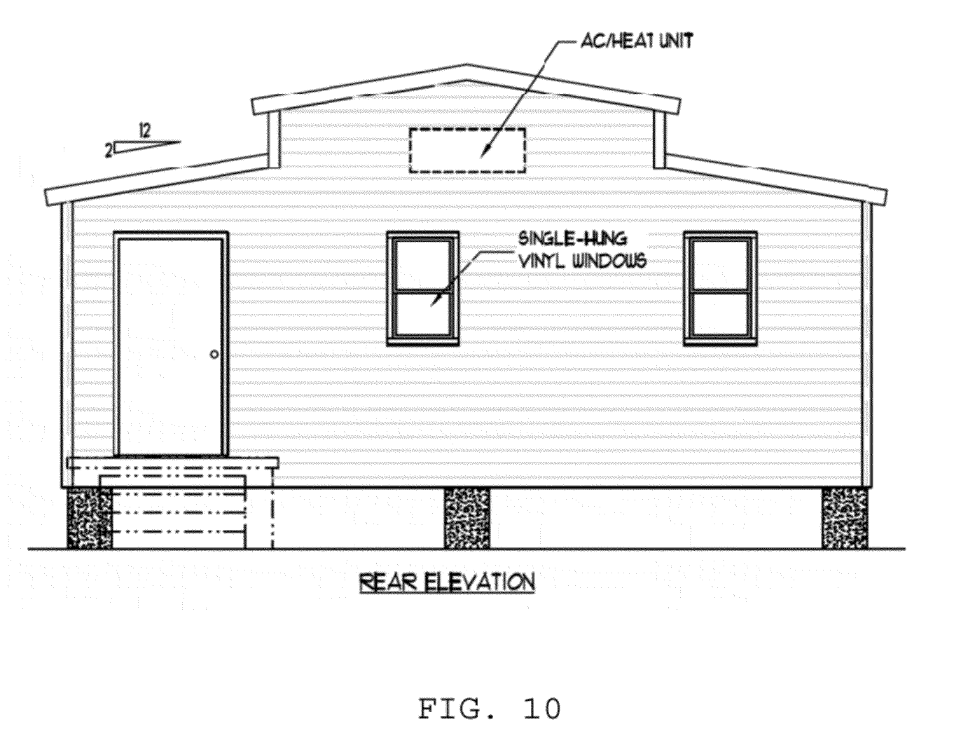

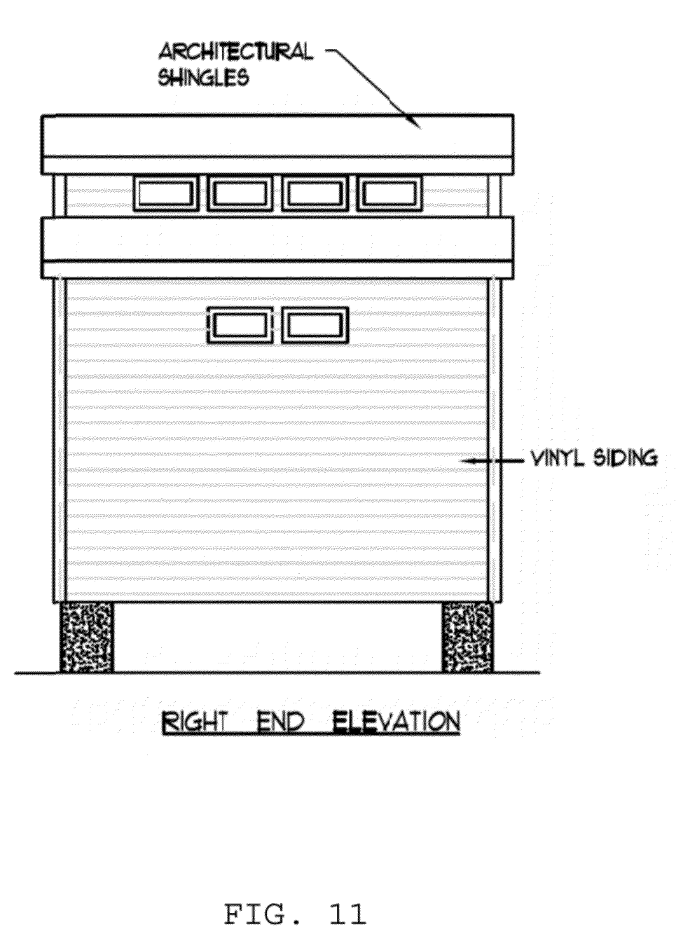

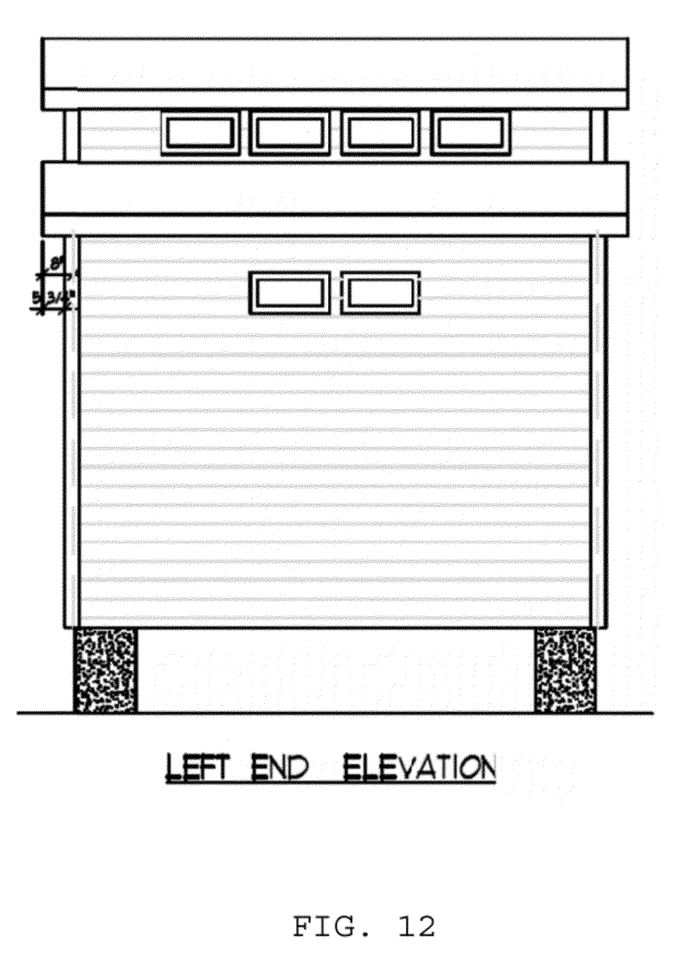

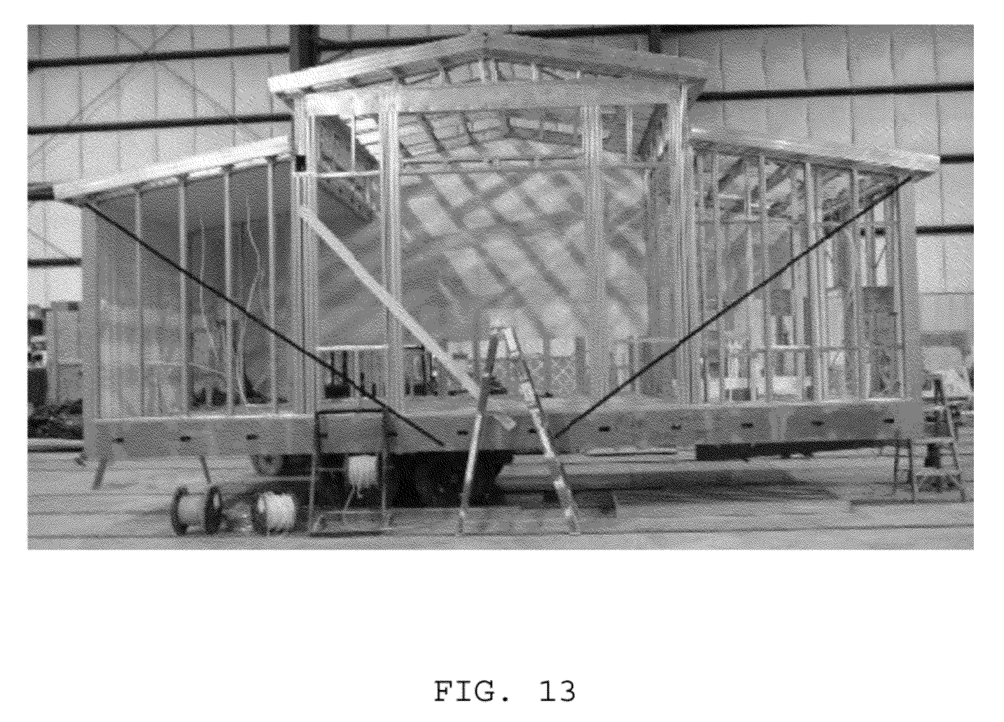

One of the objects of the present invention is to provide a modular structure that allows for simple and low cost building constructions. This objective has been accomplished in accordance with certain of the principles of this invention by providing a building module comprising a rectangular configuration and preferably in the dimensions of about 12 feet in width by about 24 feet in length. In one preferred embodiment of the invention, the modular structure comprises four sides made from typical home building materials, such as wood or metal framing materials. The exterior of the dwelling is also not limited in materials, and can for example comprise vinyl, wood, or aluminum siding. Brick can also be used, but is more expensive and difficult to ship in manufactured form. The roof can be of any configuration as well. What is important is that the MEDCottage structure be rigid and capable of retaining its shape, i.e., the walls should resist failure when exposed to an impact or wind that most dwellings would be exposed to. For example, a flexible fabric, such as vinyl or cloth (e.g., used for tents) would not typically be used as walls of the MEDCottage. Additionally, the walls and roof should together fully enclose an interior space. This interior space can further include a ceiling along the roof line or in a plane intersecting the top edges of the walls. Exemplary views of portable dwelling units of the invention are shown in FIGS. 8-13.

The durability of the installed structure can be measured by the impact resistance and the wind resistance of the walls. Unlike other portable dwelling units, such as tents and the like, the dwellings of the present invention are configured to be comparable in durability to permanent dwellings. For example, when exposed to the elements such as wind, rain, sleet, snow, and hail, the walls of the dwellings of the invention will not fail. In particular, the walls when installed for use, will resist winds of up to 100, 150, or 200 mph without failure, i.e., the framing of the walls (i.e., studs) will not detach from the foundation or other walls when winds of 100, 150, or 200 mph are directed normal to the outside surface of the wall. Ideally, the walls can withstand an impact velocity of 20-80 feet/sec; 50-100 fps; or 75-150 fps.

An embodiment of the present invention comprises a modular structure that comprises a kitchen, a bathroom and a bedroom. There are several features that may be added to each of the rooms in order to provide maximum protection and comfort. The kitchen may comprise a refrigerator, a microwave, a stacked washer and dryer, a timed medication dispenser, and any combination thereof. The bathroom may comprise a shower, a shower drain, a sink, a toilet, a monitoring device that allows for the detection of weight, temperature and urine content, and any combination thereof. The bedroom may comprise a bed, a second Murphy bed for caregiver's visits, and any combination thereof. The modular structure may further comprise lighting with additional lighting at hip, knee, and/or foot level to provide greater illumination of objects on the floor and help prevent falls, pressurized ventilation that prevents outdoor pathogens from entering or exiting, a lift that could easily transport the occupant from one room to the other, a virtual companion system that provides reminders of tasks such as taking medication, and any combination thereof.

The dwelling units can comprise a positive or negative pressure system for pushing air out of or pulling air into the housing interior at a selected rate and for keeping contaminants out of or in the interior. For example, patients with compromised immunity and needing isolation from external sources of contagions, can be housed in the dwelling units equipped with a positive pressurization system. Air can be filtered and pulled into the housing interior from an external source, then caused to be pushed out of the housing interior. If a door or window of the dwelling unit is opened, the pressurization system can be caused to react accordingly, for example, by pumping more air into the housing interior to compensate for the loss in pressure differential. Alternatively, in situations where the patient himself has a communicable disease, such as tuberculosis (TB), the housing interior can be subjected to a negative pressure atmosphere to contain contagions within the housing interior and/or cause the air within the housing interior to be filtered to remove the contagions thus preventing escape of the contagions from the dwelling. The system can be programmed to accomplish up to 20 air changes per hour (ACH), such as from about 5-10, or about 8-15, or about 12-18, or about 16-20 ACH, as needed for a particular patient.

Especially preferred are such portable dwellings with no ante-room. An ante-room is needed in a hospital setting to insulate a patient from the rest of the hospital when the patient is in a compromised immunity state or the patient has contracted an infectious disease. Using an ante-room decreases the risk of infection into or out of the isolation room. Typically, in a hospital setting the negative or positive air pressure systems are not sufficient alone to contain contagions within the isolation room or keep contagions from entering. The ante-room is a chamber that provides a transition from the main portion of the hospital to the isolation room. These passageways may or may not have their own air pressurization systems to provide an additional buffer against potential contagions. Dwellings of the invention do not require an ante-room, although one could be installed, however, it is preferred not to have an ante-room.

Monitoring systems alone or in combination with the medical dwellings are provided as embodiments of the invention. Multiple monitoring systems may also be used. The monitoring systems may include, but are not limited to, health monitoring, safety monitoring, security monitoring, comfort monitoring, and any combination thereof. In various embodiments, the health monitoring systems are systems that monitor physiological signals generated by an occupant of the modular structure and process the signals to determine any of a variety of physiological parameters of the individual. For example, in some cases, a health monitoring system can determine any of a variety of physiological parameters of an individual, including but not limited to respiratory rate, SpO₂ levels, inspiratory time, expiratory time, inspiratory flow, expiratory flow, tidal volume, minute volume, apnea duration, breath sounds, rales, rhonchi, stridor, changes in breath sounds such as decreased volume or change in airflow, and any combination thereof. In addition, in some cases the physiological monitoring system monitors other physiological sounds, such as heart rate to help with probe-off detection, heart sounds (e.g., S1, S2, S3, S4, and murmurs), and changes in heart sounds such as normal to murmur or split heart sounds indicating fluid overload. Moreover, the health monitoring system may monitor systolic and diastolic blood pressure, as well as weight, temperature, and any combination thereof. In certain embodiments, the health monitoring system can provide previous readings for comparison. Monitoring systems of embodiments of the invention can be operably configured to communicate with any computer, phone, or mobile device, especially including smart phones, for communicating the monitored information (or a notification generated in response thereto) from or to the patient to or from a caregiver. Even further, the monitoring and notification systems may be packaged as a stand alone product used to retro-fit an existing home or dwelling to extend independence of the patient and increase caregiver communication with the patient.

The health monitoring system of certain embodiments includes one or more individual monitoring devices that can connect to a shared network using open architecture communications standards. The individual monitoring devices of certain embodiments include a physiological monitor coupled with a network interface. The physiological monitor includes one or more sensors and a sensor processing device for processing signals from the sensors. The network interface receives physiological information from the sensor processing device and transmits this information over the shared network. The network interface (e.g., dashboard) may connect to a variety of physiological monitors. In addition, the network interface of various implementations is a portable bedside device assigned exclusively to one individual. In certain embodiments, the network interface facilitates establishing a network connection directly with end users over the shared network. These end users, including caregivers, may receive physiological information, alarms, and alerts from the network interface on an electronic device, such as a PDA, laptop, computer, or the like and any combination thereof. One of ordinary skill in the art, with the benefit of this disclosure, would know the type of health monitor needed to provide optimum monitoring.

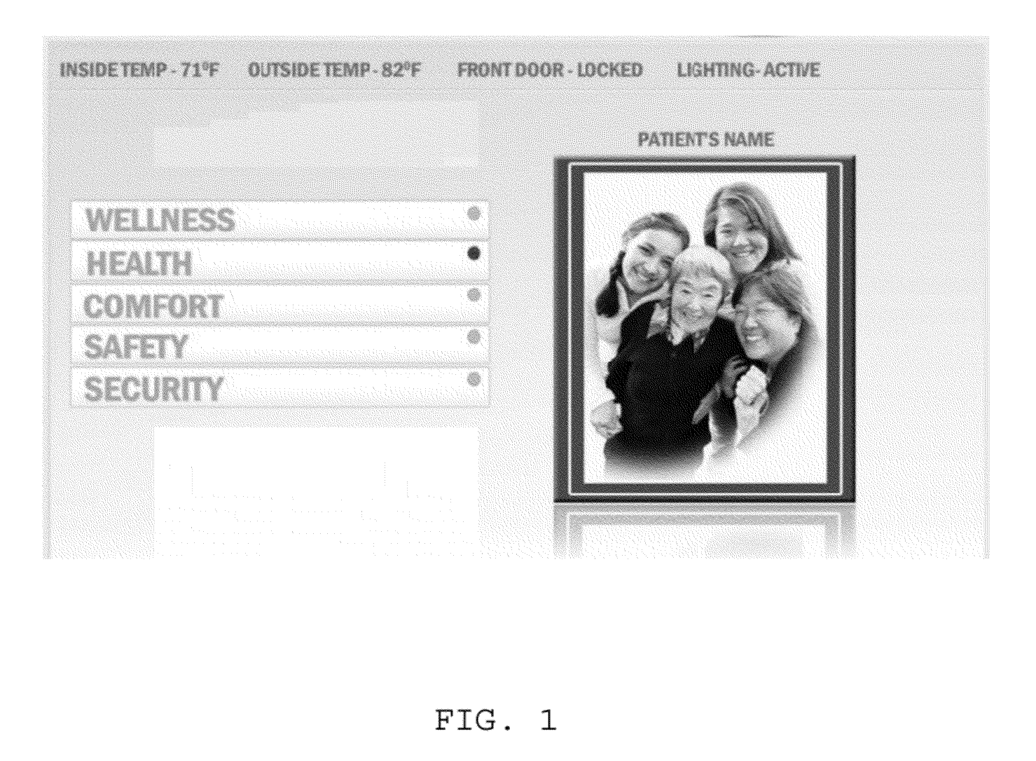

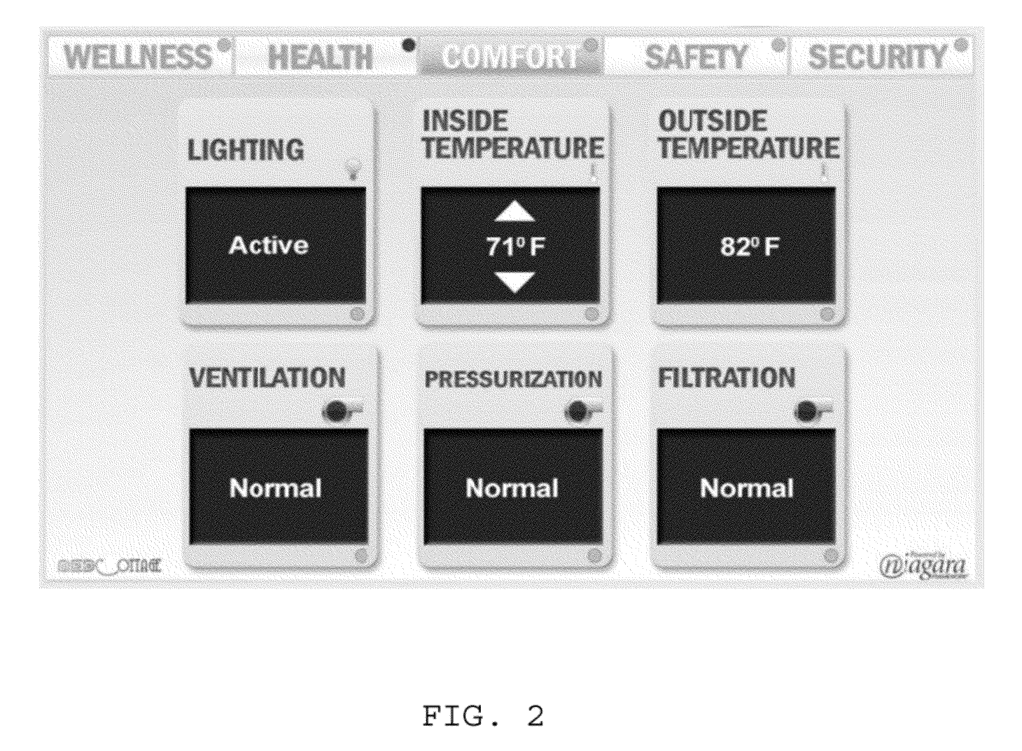

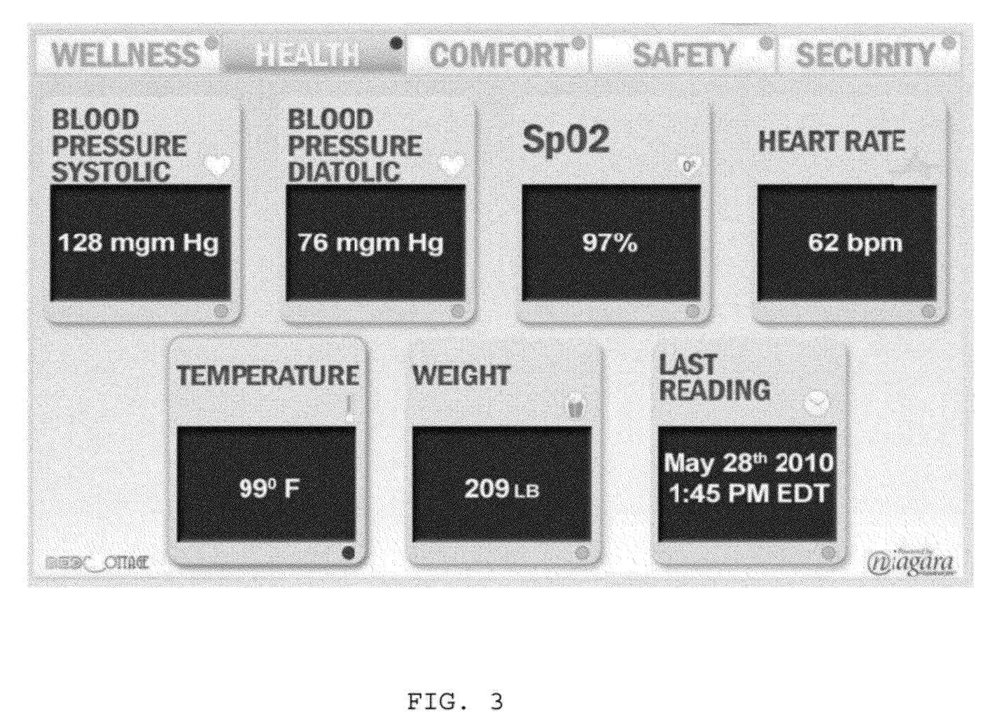

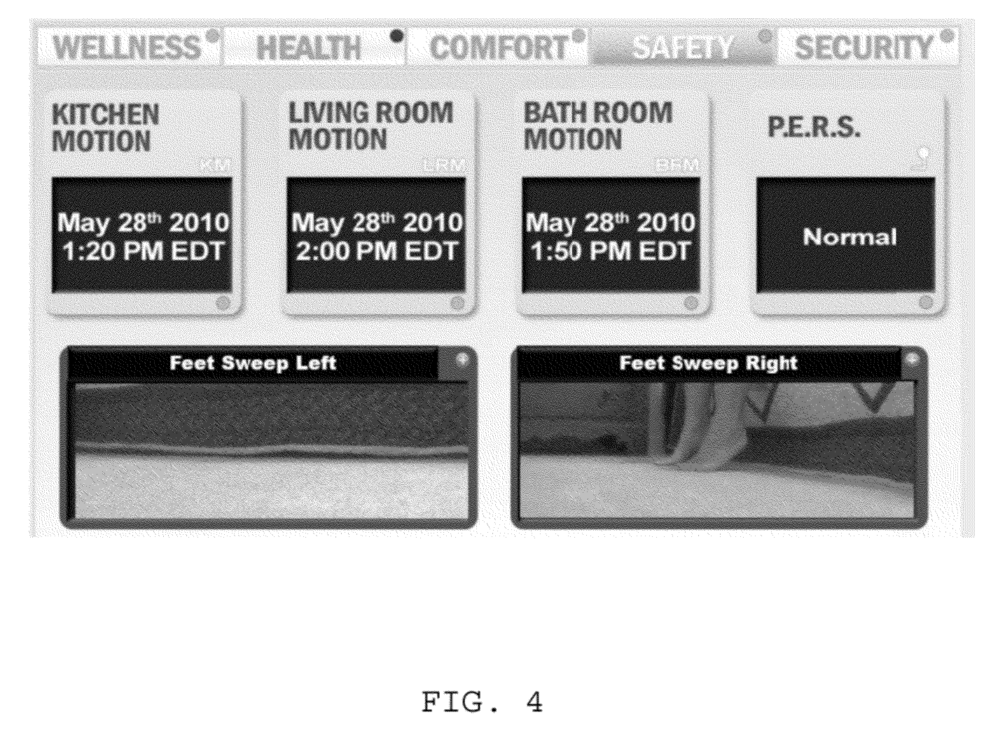

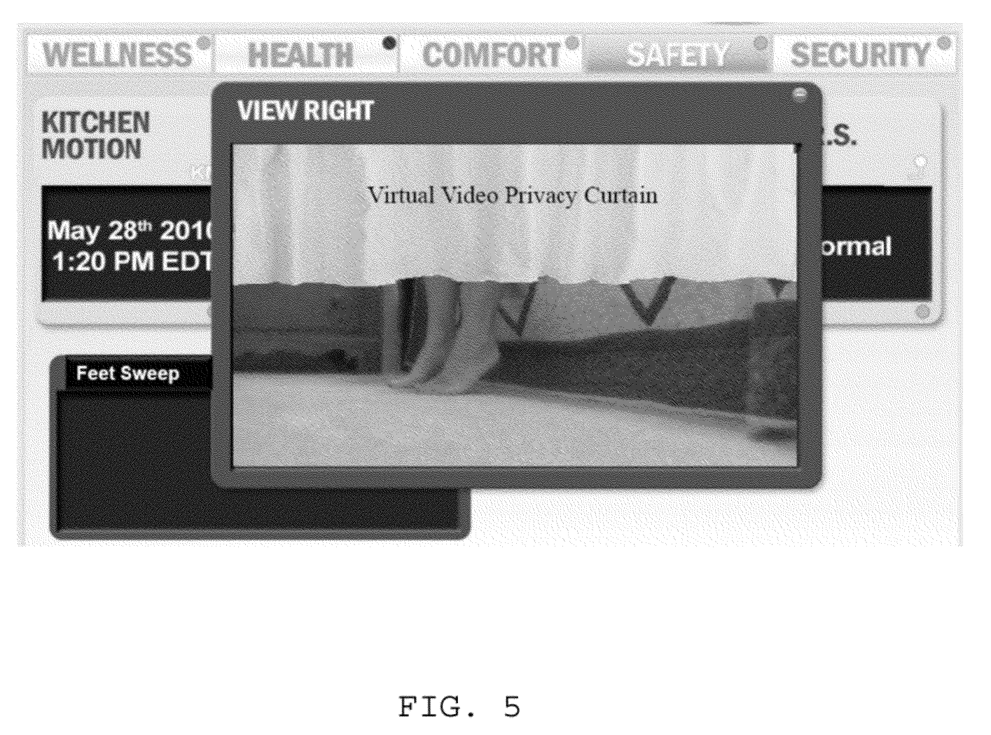

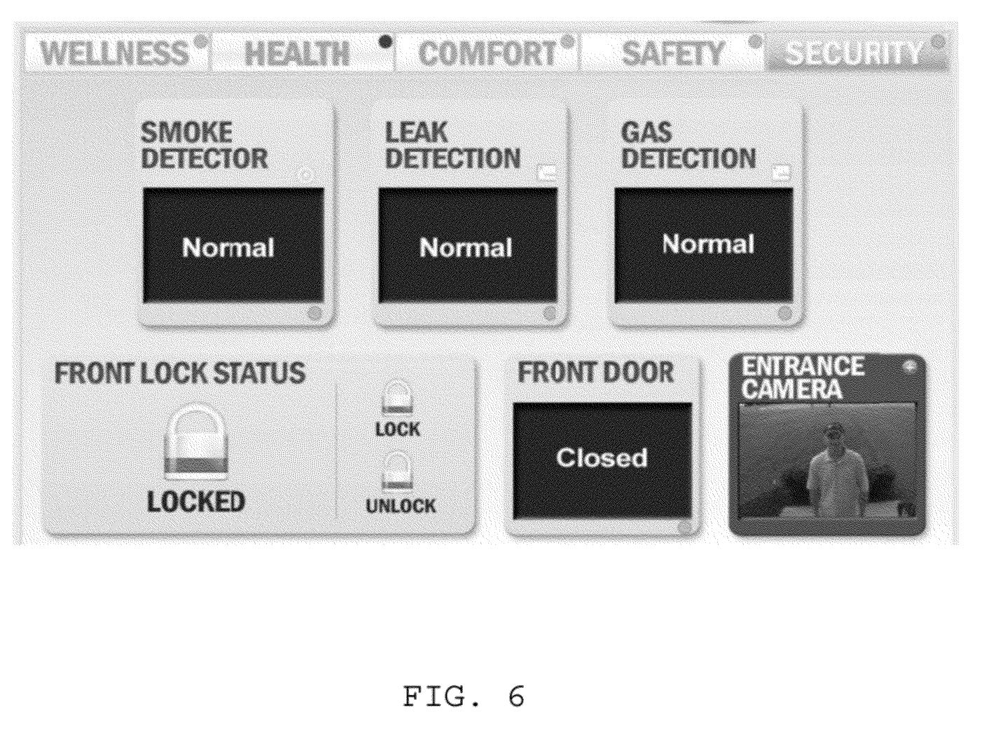

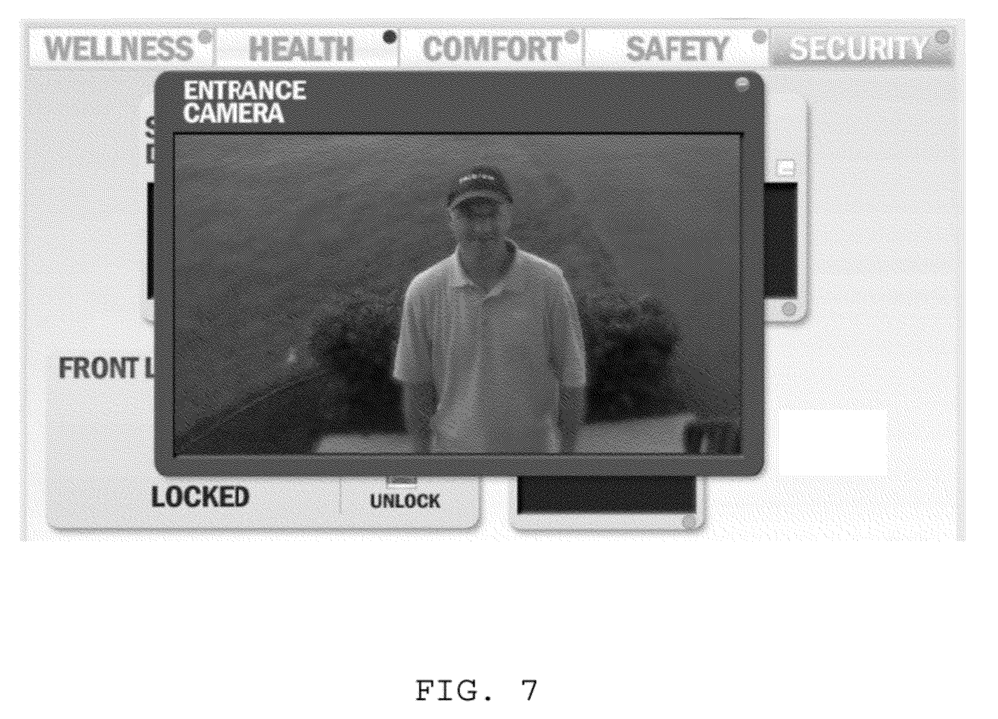

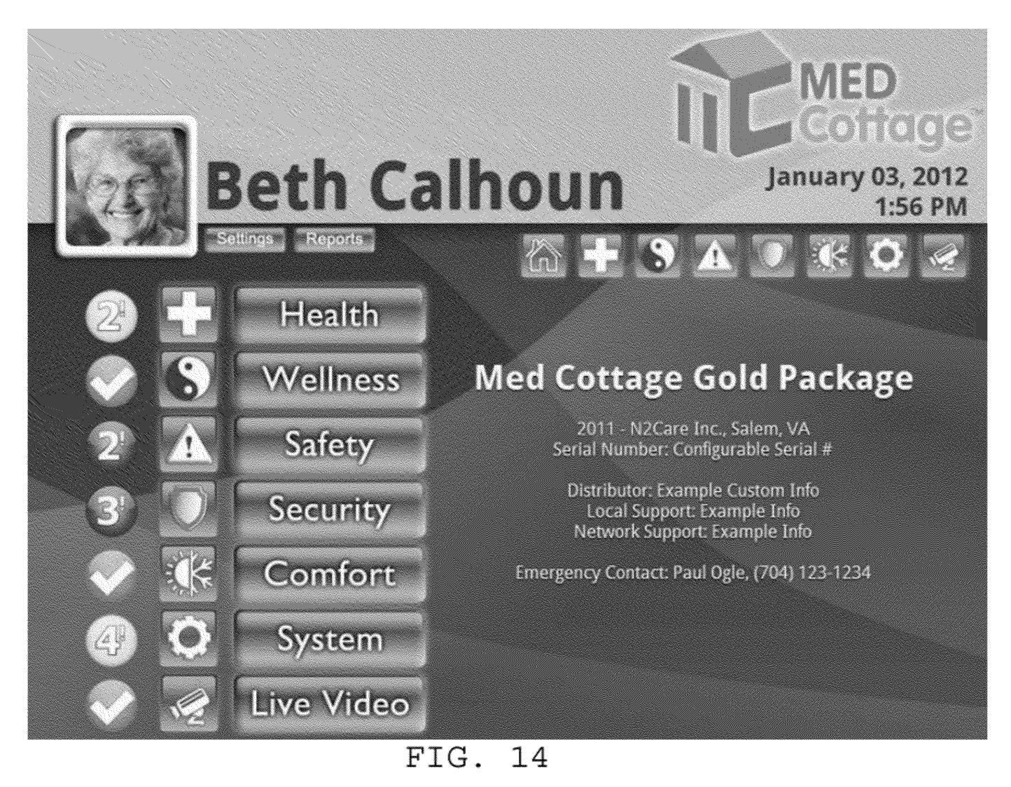

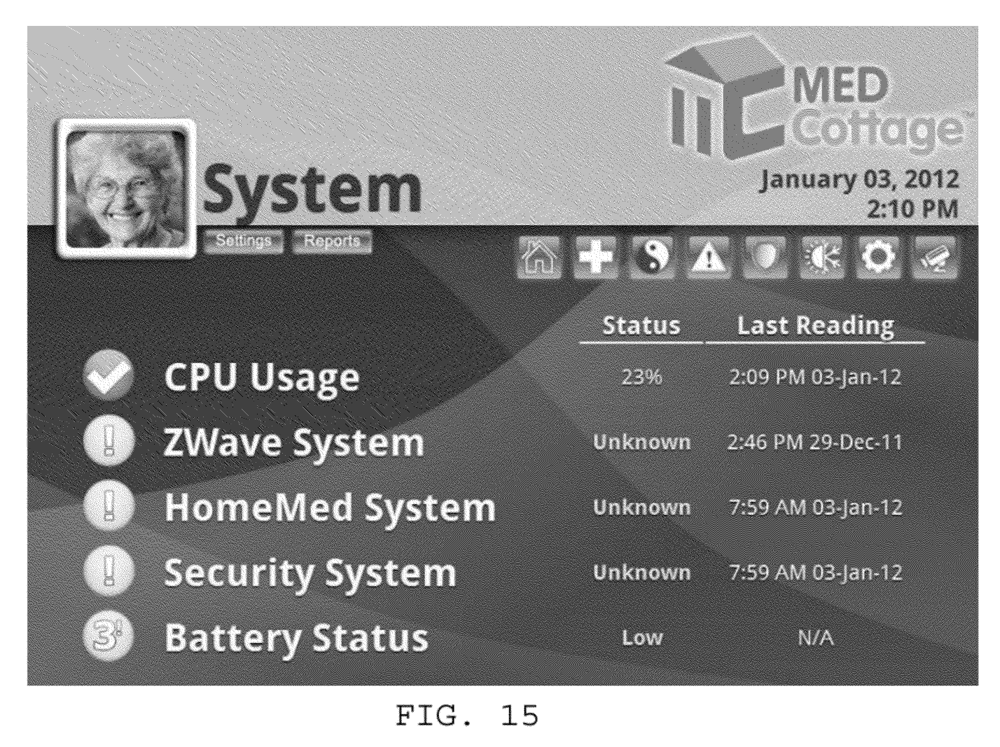

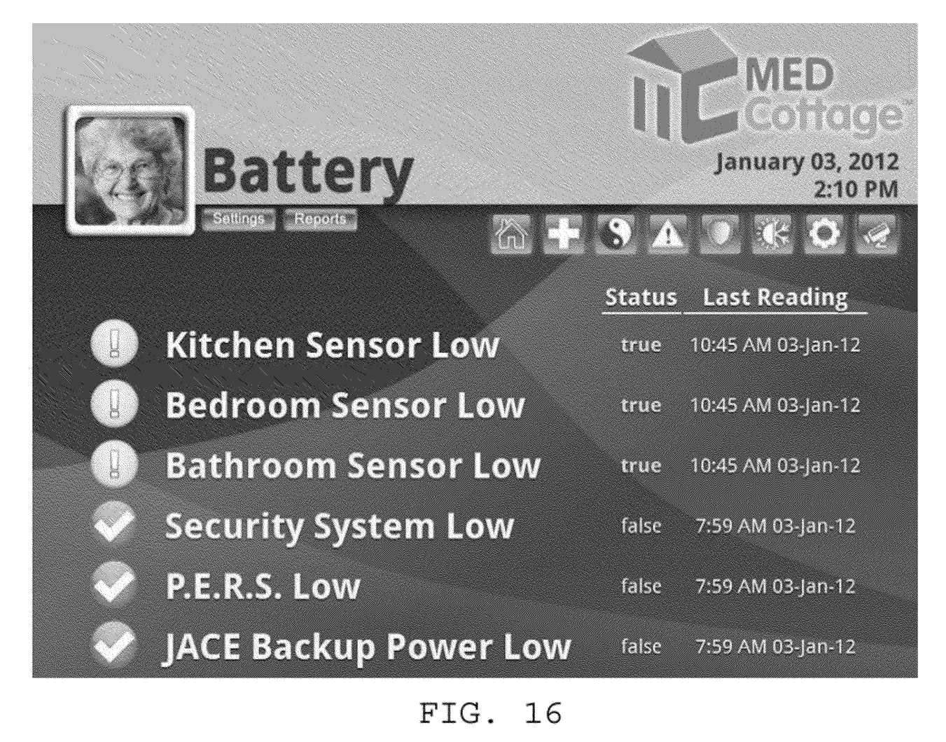

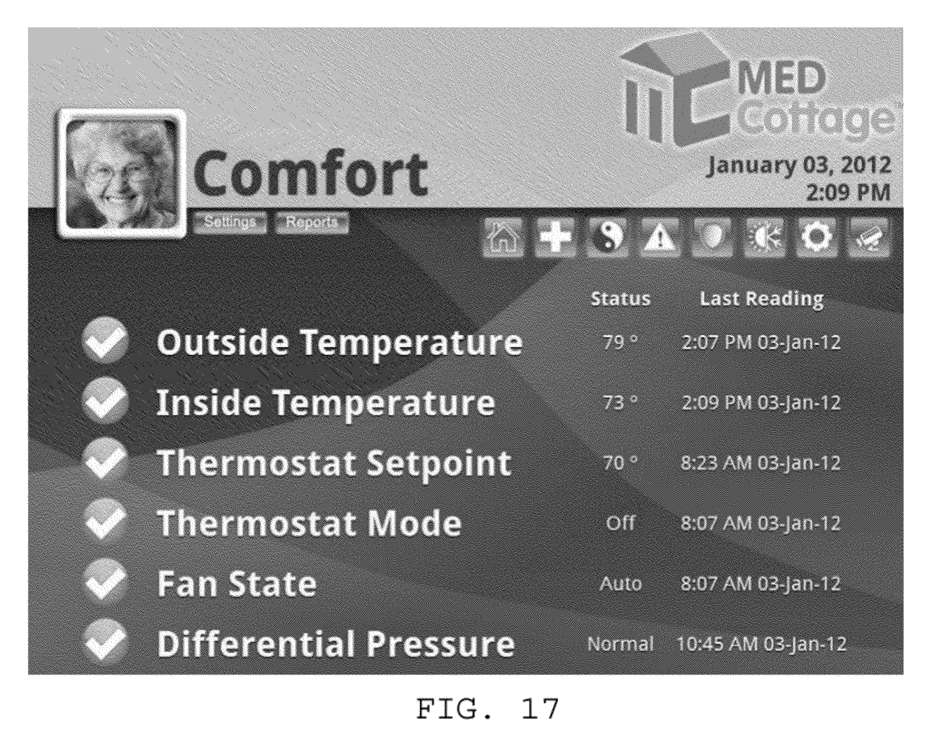

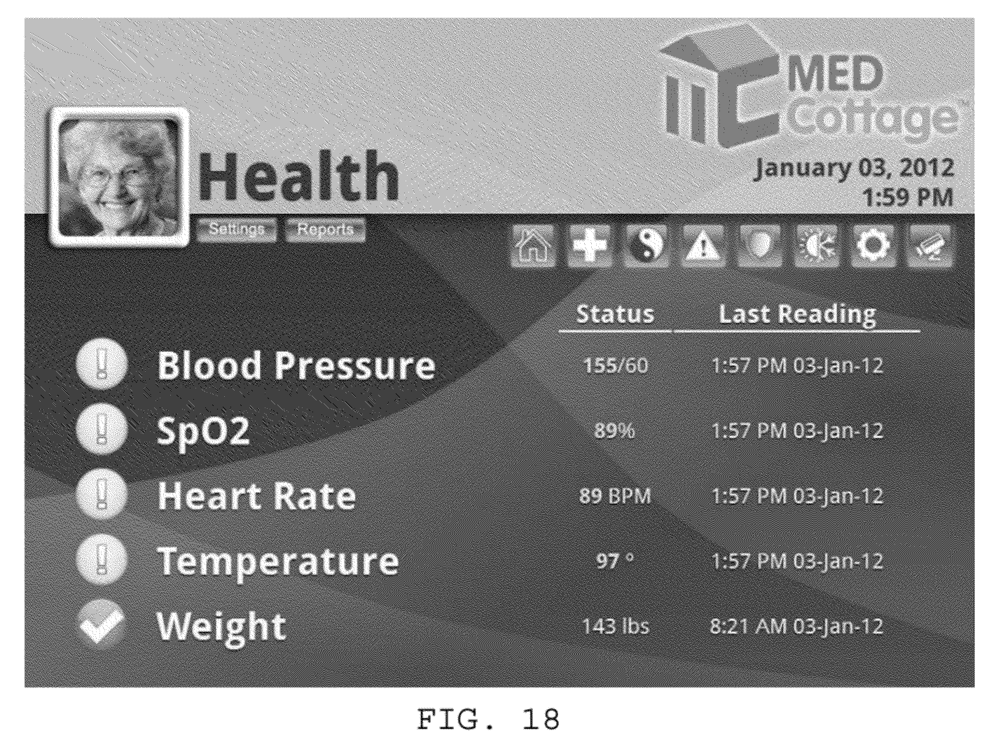

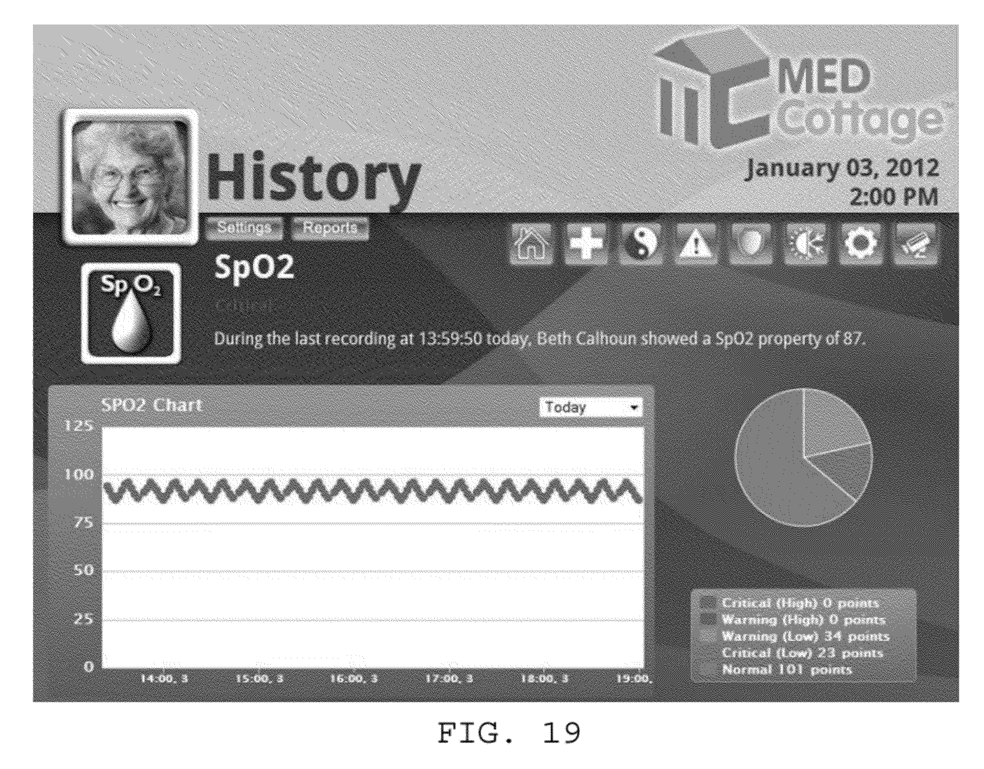

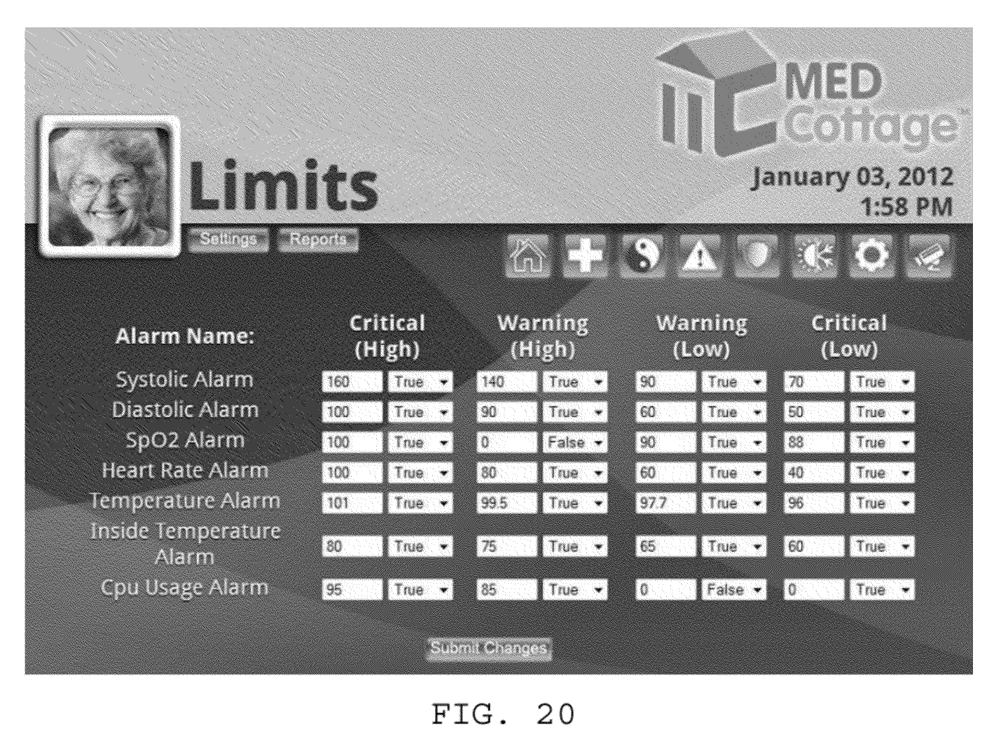

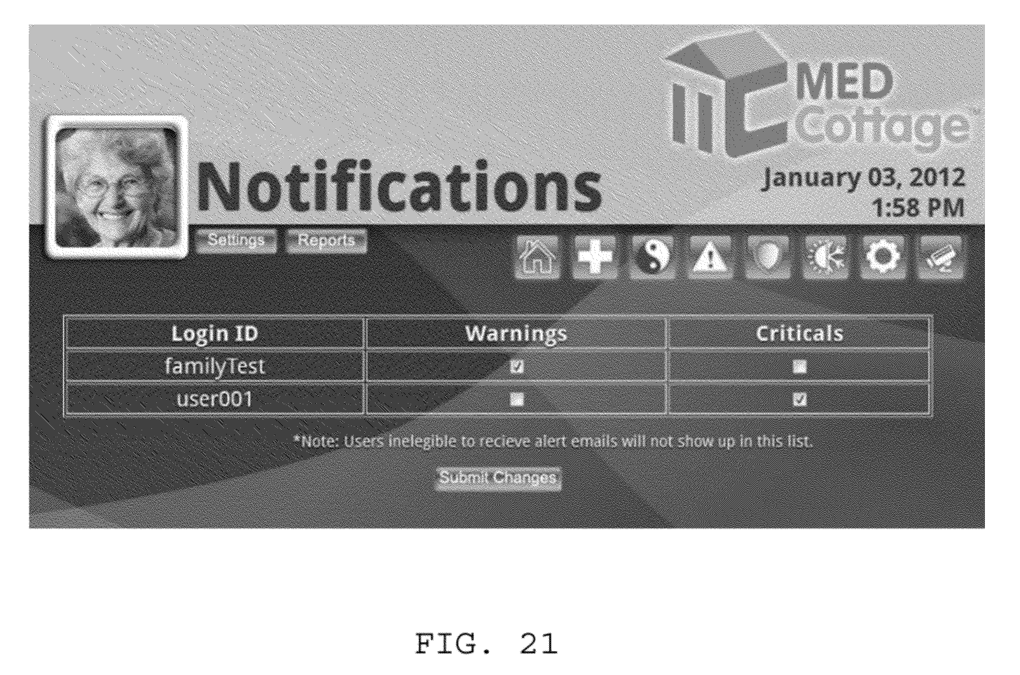

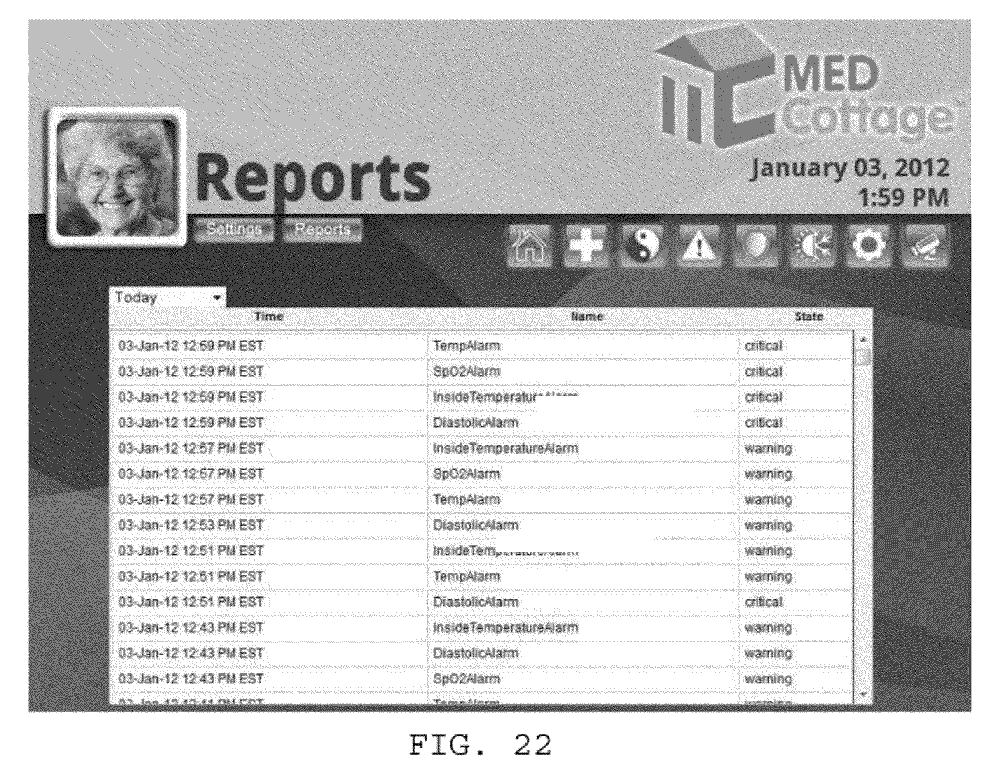

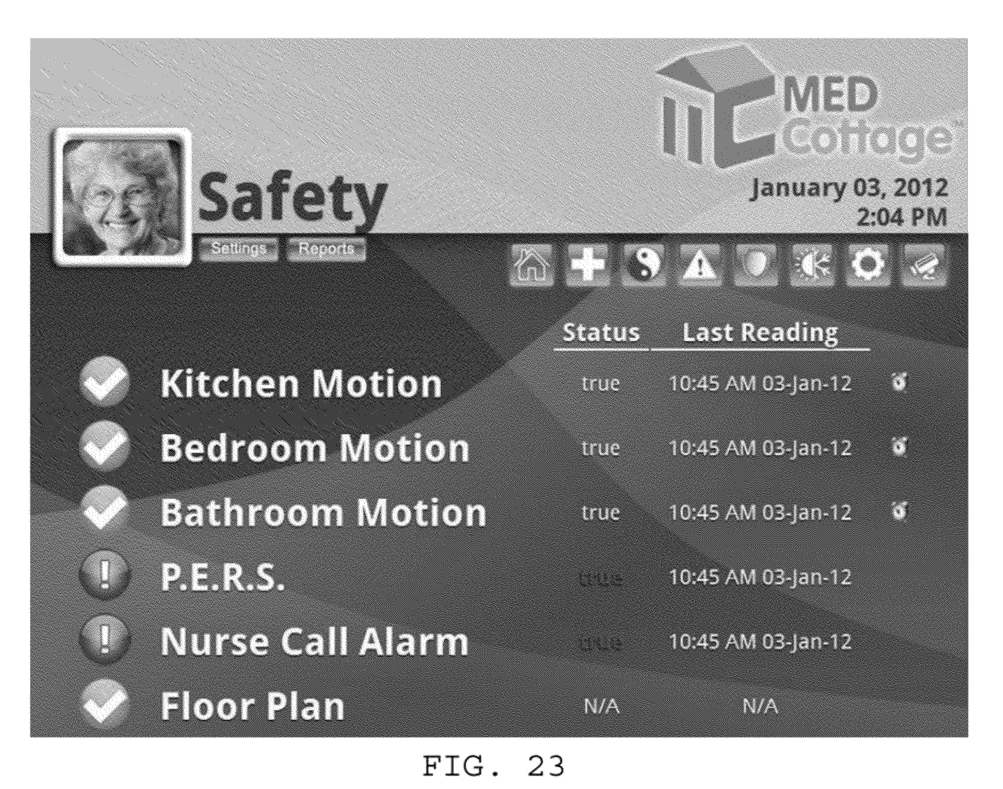

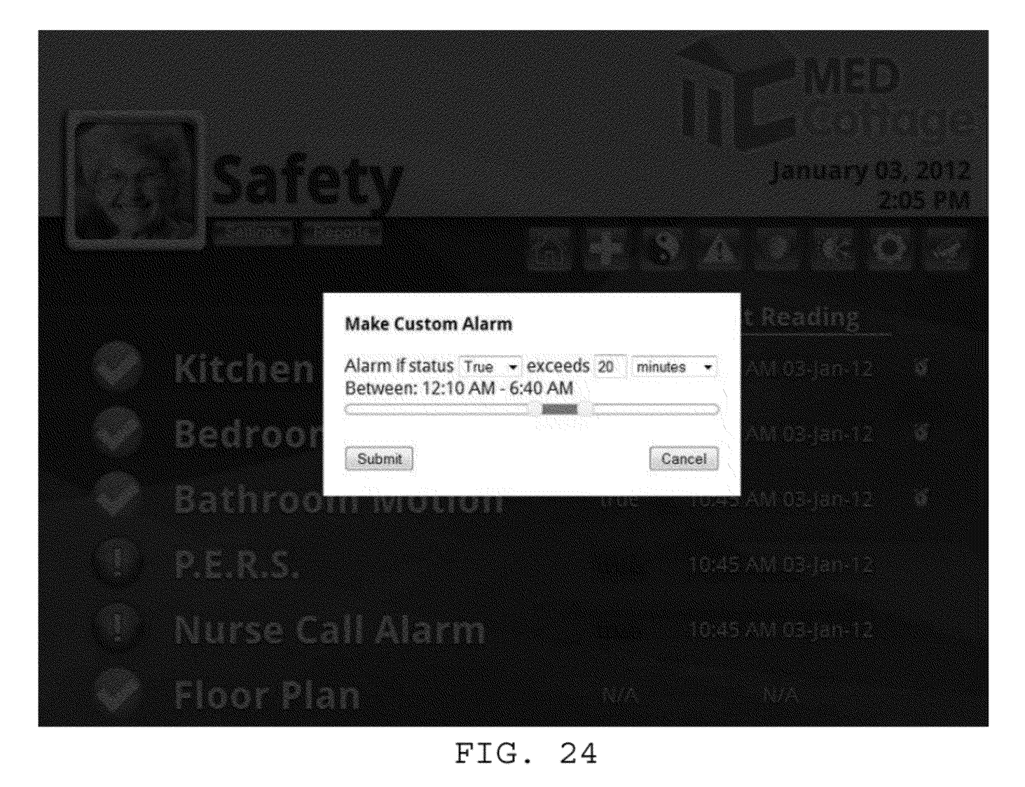

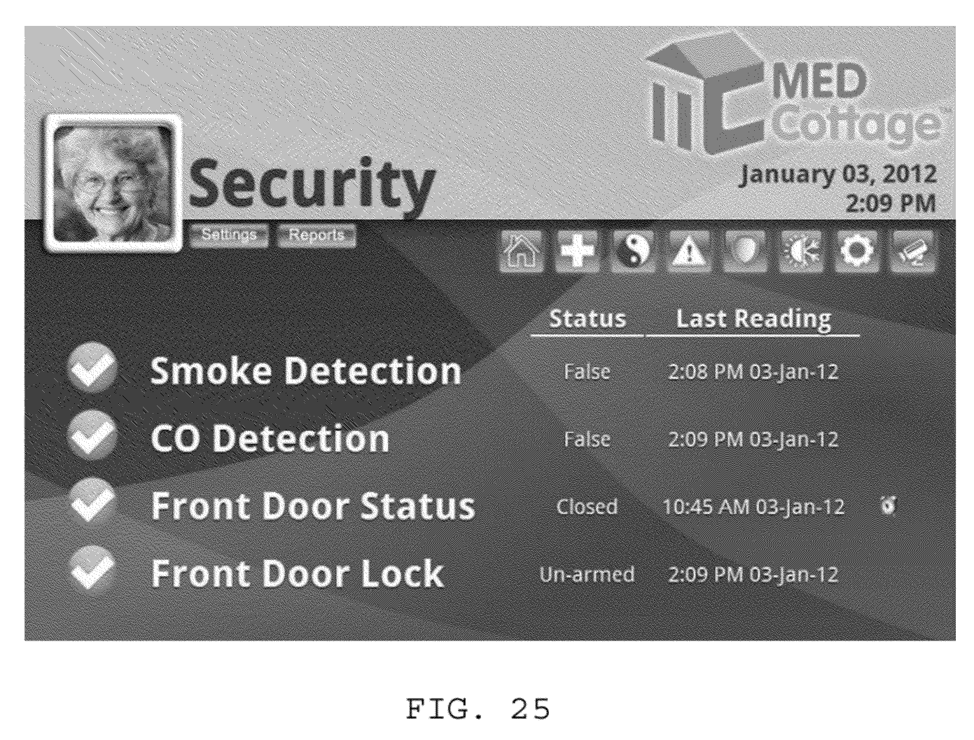

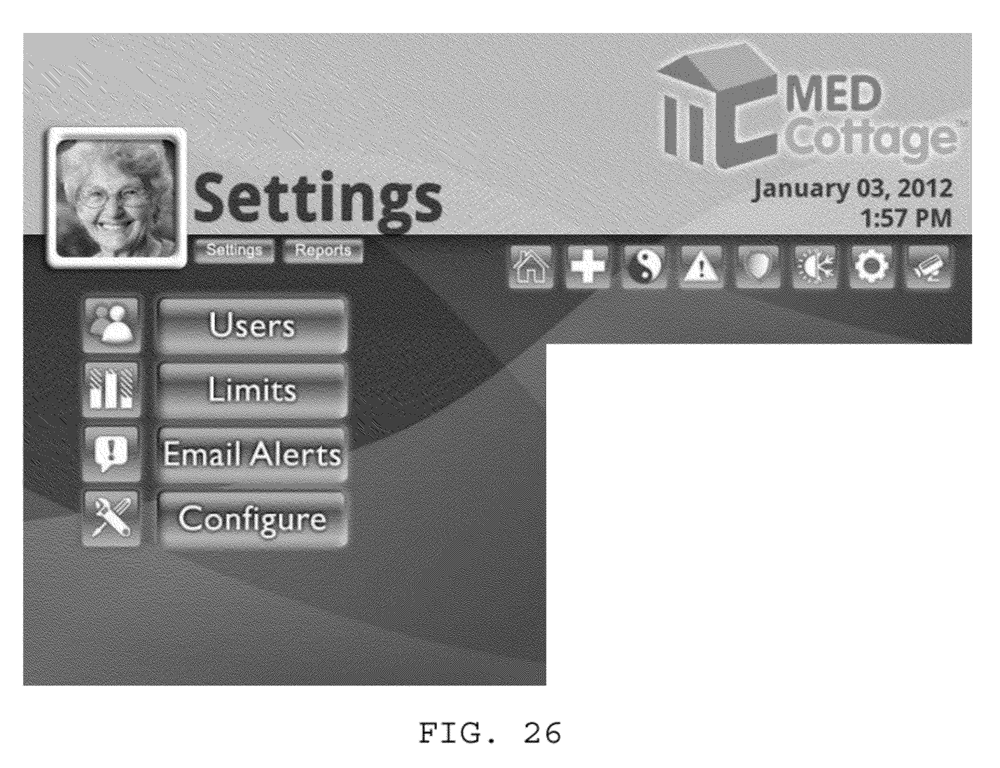

The monitoring systems and portable dwelling units according to embodiments of the invention comprising such monitoring systems, for example, can be configured according to the customized needs of a particular patient or can be standardized for mass production and can include safety, environmental, health, security, comfort, wellness, or other criteria as demonstrated in the exemplary dashboards shown in FIGS. 1-7 and FIGS. 14-26.

Preferred is a portable dwelling or portable according to embodiments of the invention described in this application, wherein the monitoring system comprises or is in operable communication with a dashboard interface with means for one or more of: communicating measured conditions to a caregiver in a remote location; remotely setting patient-specific criteria for desired environmental and patient conditions within the housing interior; and remotely controlling equipment in or near the portable dwelling or room for adjusting the measured conditions to meet the desired conditions. For example, a caregiver can remotely control equipment in the MEDCottage from a remote location, usually in response to an alarm that a pre-selected condition is not being met. As an illustration, if a patient is using an oxygen mask while sleeping and the patient's SpO₂ level decreases to an unacceptable level, the caregiver using the dashboard at a remote location can increase the rate of flow of oxygen to the patient's mask. The dashboard control can be used to control from a remote location any device for administering patient care or for altering the environment within the housing interior, including lighting, temperature, and factors relating to patient care or comfort.

In various embodiments, the safety monitoring systems are non-contact systems that can detect and classify types of movements or postures associated with an individual's movements, providing caregivers with an alarm to react and thereby minimizing risk associated with a fall or injury. The sensors used would trigger for any motion that occurs in the field of view, regardless of the source of motion. Once an object of interest has been identified, sample images are collected. Sample images can come from a variety of sources including actual images of objects that are captured using a remote device, such as a digital camera, a video camcorder or any other suitable apparatus.

Preferred embodiments include a privacy-conscious patient monitoring system comprising: means for capturing an image of a patient in a room; means for transmitting the image in whole to a caregiver in a remote location; and means for communicating only a restricted view of the image to the caregiver by blacking out or distorting an undesired portion of the image. Means for capturing an image of a patient can include one or more video devices or camcorders or cameras, or any means for capturing or recording a visual image of the patient in the housing interior. The entire image or images can then be transmitted over a network or the internet operably connected with the video equipment to a location remote or removed from the dwelling. The digital file recorded by the video equipment can also be transmitted directly from the video equipment or transferred to a computer that is in operably communication with a network or internet to transmit the images to a caregiver at another location. Means for communicating a restricted view of the image can include superimposing a second opaque image over the undesired portion of the image or digital instructions to cause pixels in the display device to show a distorted, grayed-out or blacked out image for the portion of the image that is not to be shown, i.e., the privacy revealing portion of the image.

The privacy-conscious patient monitoring system can comprise means for removing the restriction to allow unrestricted viewing of the image by the caregiver, for example, by using a pass code, voice-recognition software, fingerprint recognition software, or combinations thereof.

In preferred embodiments of the present invention the outputted field of view may be reduced in order to maintain the individual's privacy. By way of illustration, these sensors will detect a much larger view but the output would be covered by an object, such as a virtual curtain, that may be removed upon the detection of a problem or a fall. In some embodiments, the caregiver may only see in the range of from about the ground to about 2 feet off the floor. In embodiments, this field of view restriction can be lifted by the caregiver providing a passcode or other security gate such as ocular, fingerprint, or voice recognition technology.

Some monitoring systems of the invention can be configured to operate with sufficient selectivity to detect a fall event by sending the captured image to a processing device. The processing device uses algorithms to detect change in position from one image to another and provides an output signal based on the results of the analysis. In various examples, the use of equipment that allow for image capture in the dark may allow capture of suitable sample images 24 hours a day. The present invention provides a method for image processing, comprising the steps of: capturing images presented in a field of view of the image capture and reporting the image to a processing device; using the processing device to analyze the captured images and to provide a negative output signal based on the results of the analysis; and providing a modified decreased view of the images captured to the end users unless a negative output signal is provided. These end users, including caregivers, may receive movement information and images, alarms, and alerts from the safety monitors on an electronic device, such as a PDA, laptop, computer, or the like and any combination thereof. One of ordinary skill in the art, with the benefit of this disclosure, would know the type of safety monitor needed to provide optimum monitoring.

In some embodiments, the comfort monitoring systems are systems that monitor physiological parameters of the modular structure or the environment within the housing interior and process the signals to determine any of a variety of physiological parameters that may affect the comfort of the occupant of the modular structure. For example, in some cases, the comfort monitoring system may determine any of a variety of physiological parameters of the modular structure including, but not limited to, indoor temperature, outdoor temperature, lighting, ventilation, pressurization, filtration, and any combination thereof. In some embodiments of the present invention, the security monitoring systems are systems that monitor physiological parameters of the modular structure and process the signals to determine any of a variety of physiological parameters that may affect the security of the occupant of the modular structure. For example, in some cases, the security monitoring system may determine any variety of physiological parameters of the modular structure including, but not limited to, smoke detection, leak detection, gas detection, front door status (e.g., door locked, door closed), and any combination thereof. An entrance camera may be added in certain embodiments as an additional security measure.

The invention further provides a method of providing a healthcare facility to a patient comprising renting or selling a portable dwelling comprising: walls and a roof in a fixed exterior configuration enclosing a housing interior, wherein, when installed for use, the walls will not fail under wind resistance of up to 200 mph; a positive or negative pressure system for pushing air out of or pulling air into the housing interior at a selected rate and for keeping contaminants out of or in the interior; and a monitoring system with means for monitoring environmental and patient conditions within the housing interior and means for alerting a caregiver to conditions that do not meet patient-specific criteria, wherein the monitoring system includes visual means for observing the patient at any time and at any position within the housing interior.

Embodiments of the invention provide virtual assistants to provide reminders and instructions to patients at specified times concerning medical or other issues. Virtual assistants can be used to elevate the lifestyle of the patient and/or provide for cognitive stimulation for the patient. As an illustration, the virtual assistant can be a voice reminder to the patient to take their medicine at a specified time. The virtual companion can also respond to voice commands, usually given by the patient, to perform certain tasks. For instance, the patient could instruct the virtual companion to dial a phone number or record in text form a desired shopping list of the patient.

Further embodiments provide patient record systems operably configured to store a patient's entire medical history and be accessible only by certain caregivers, under specified conditions, and at specific times, while the patient retains control of and access to the file and is capable of accessing the information at any time. Files can be grouped by families as well, if desired, and access can be granted to an entire grouping with one set of passcodes or identification numbers. In embodiments, the medical records can be uploaded electronically by hospitals, doctor's, and other professional medical staff to a “cloud,” a server or part of a server hosted by a third party. Data can be accepted by the cloud only if certain criteria are entered, such as a correct combination of a passcode, patient identification number, home address, or other identifying information to verify the information being uploaded to the cloud is information pertaining to that patient. Medical records, including dental x-rays, CT scans, blood results, family history, exam results, and test results can be uploaded, organized into files, and stored on the cloud. The patient to whom the records belong can then access the information on the cloud at any time or grant access to the cloud or portions thereof by specific caregivers. Access to others can be granted for periods of time or can be unlimited as to time. Methods of using a cloud to access or provide medical information to a patient or others are included within the scope of the present invention. Systems comprising means for accessing the information on the cloud, including a network of one or more computers in operable communication with the cloud, are also included.

The present invention has been described with reference to particular embodiments having various features. It will be apparent to those skilled in the art that various modifications and variations can be made in the practice of the present invention without departing from the scope or spirit of the invention. One skilled in the art will recognize that these features may be used singularly or in any combination based on the requirements and specifications of a given application or design. Other embodiments of the invention will be apparent to those skilled in the art from consideration of the specification and practice of the invention. It is intended that the specification and examples be considered as exemplary in nature and that variations that do not depart from the essence of the invention are intended to be within the scope of the invention.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

1. A portable dwelling comprising:
a dwelling comprising walls and a roof in a fixed exterior configuration enclosing a housing interior, wherein, when installed for use, the walls will not fail under wind resistance of up to 200 mph, and wherein the dwelling is portable;
a positive or negative pressure system for pushing air out of or pulling air into the housing interior at a selected rate and for keeping contaminants out of or in the interior;
and a monitoring system with means for monitoring environmental and patient conditions within the housing interior and means for alerting a caregiver to conditions that do not meet patient-specific criteria, wherein the monitoring system includes visual means for observing the patient at any time and at any position within the housing interior.

2. A portable room comprising:
a dwelling structure with walls and a ceiling in a fixed exterior configuration enclosing a housing interior operably configured, shaped and sized, for installation within a garage;
a positive or negative pressure system for pushing air out of or pulling air into the housing interior at a selected rate and for keeping contaminants out of or in the interior;
and a monitoring system with means for measuring and monitoring environmental and patient conditions within the housing interior and means for communicating the conditions to a caregiver and means for alerting a caregiver to conditions that do not meet patient-specific criteria, wherein the monitoring system includes visual means for observing the patient at any time and at any position within the housing interior.

3. The portable dwelling of claim 1, wherein the monitoring system comprises or is in operable communication with a dashboard interface with means for one or more of:
communicating measured conditions to a caregiver in a remote location;
remotely setting patient-specific criteria for desired environmental and patient conditions within the housing interior; and
remotely controlling equipment in or near the portable dwelling or room for adjusting the measured conditions to meet the desired conditions.

4. The portable dwelling or room of claim 1, wherein, when installed for use, the walls will not fail under an impact velocity of 50-100 fps.

5. The portable dwelling of claim 1, further comprising a filtering system with means for filtering the air entering or exiting the housing interior.

6. The portable dwelling or room of claim 1, further comprising a virtual companion system.

7. The portable dwelling of claim 1, further comprising safety lighting.

8. The portable dwelling of claim 1, wherein the monitoring system comprises means for determining any physiological parameter of a patient selected from: respiratory rate, SpO₂ levels, inspiratory time, expiratory time, inspiratory flow, expiratory flow, tidal volume, minute volume, apnea duration, breath sounds, rales, rhonchi, stridor, changes in breath sounds such as decreased volume or change in airflow, heart rate, heart sounds, systolic and diastolic blood pressure, weight, temperature, and any combination thereof.

9. The portable dwelling of claim 1, wherein the monitoring system comprises means for determining any physiological parameter of the housing interior selected from: indoor temperature, outdoor temperature, lighting, ventilation, pressurization, filtration, air scrubber requirements, and any combination thereof.

10. The portable dwelling of claim 1 with no ante-room.

11. A privacy-conscious patient monitoring system comprising:
means for capturing an image of a patient in a room;
means for transmitting the image in whole to a caregiver in a remote location; and
means for communicating only a restricted view of the image to the caregiver by blacking out or distorting an undesired portion of the image.

12. The privacy-conscious patient monitoring system of claim 11, wherein privacy of the patient is protected by blacking out or distorting the undesired portion of the image.

13. The privacy-conscious patient monitoring system of claim 11, wherein the viewable restricted view of the image is from floor level to about 2 feet from the floor.

14. The privacy-conscious patient monitoring system of claim 11 comprising means for removing the restriction to allow unrestricted viewing of the image by the caregiver.

15. The privacy-conscious patient monitoring system of claim 11, wherein the means to remove the restriction is a pass code, voice-recognition software, fingerprint recognition software, or combinations thereof.

16. A method of providing a healthcare facility to a patient comprising renting or selling the portable dwelling of claim 1.
